(19) United States
(12) Patent Application Publication
(10) Pub. No.: US 2024/0418224 A1
(43) Pub. Date: Dec. 19, 2024

(54) CONSTANT VELOCITY JOINT FOR PROPELLER SHAFT AND PROPELLER SHAFT

(71) Applicant: Hitachi Astemo, Ltd., Hitachinaka-shi, Ibaraki (JP)

(72) Inventors: Hidekazu AOKI, Hitachinaka-shi, Ibaraki (JP); Kenichiro ISHIKURA, Hitachinaka-shi, Ibaraki (JP)

(73) Assignee: Hitachi Astemo, Ltd., Hitachinaka-shi, Ibaraki (JP)

(21) Appl. No.: 18/689,684

(22) PCT Filed: Jul. 7, 2022
(86) PCT No.: PCT/JP2022/026931

§ 371 Date: Mar. 6, 2024

(30) Foreign Application Priority Data
Sep. 10, 2021 (JP) 2021-147399

(51) Int. Cl. F16D 3/227; F16D 3/223

(52) U.S. Cl. CPC F16D 3/227; F16D 2003/22309

(57) ABSTRACT

The present invention comprises an outer race member including an outer race groove portion that is provided at an inner periphery of the outer race member formed into a cylindrical shape, in a recessed manner so as to be angled to a rotational axis of a constant velocity joint, a first outer race groove end portion situated on a first propeller shaft side of the outer race groove portion, and a second outer race groove end portion situated on a second propeller shaft side of the outer race groove portion; a ball member disposed in the outer race groove portion; and an inner race member provided on an inner peripheral side of the outer race member and connected to the second propeller shaft of a propeller shaft, the inner race member including an inner race groove portion provided at an outer periphery of the inner race member in a recessed manner so as to be angled to the rotational axis of the constant velocity joint and intersect with the outer race groove portion, the inner race groove portion being formed to have a larger outer diameter than the second propeller shaft, a first inner race groove end portion situated on the first propeller shaft side of the inner race groove portion, and a second inner race groove end portion situated on the second propeller shaft side of the inner race groove portion. Distance from a position at which the ball member is situated in the outer race groove portion to the first outer race groove end portion of the outer race groove portion is set longer than distance from a position at which the ball member is situated in the inner race groove portion to the second inner race groove end portion of the inner race groove portion.

### TECHNICAL FIELD

The invention relates to constant velocity joints for propeller shafts and to propeller shafts.

### BACKGROUND ART

Patent Literature 1 discloses a cross groove type constant velocity joint including an outer race member, an inner race member, a cage disposed between the outer race member and the inner race member, and a ball that is retained in an open window portion of the cage to connect the outer race member and the inner race member.

### CITATION LIST

### Patent Literature

PTL 1: JP 2018-0

### SUMMARY OF INVENTION

### Technical Problem

If the cross groove type constant velocity joint described in Patent Literature 1 is applied to a vehicle propeller shaft, the ball might slip off to the side where a propeller shaft connected to the outer race member is located when a vehicle collision causes the inner race member to slide in a rotational axis direction of the cross groove type constant velocity joint as the outer race member is formed to be shorter than the inner race member in the rotating axis direction of the cross groove type constant velocity joint. In such a situation, the ball gets stuck between the propeller shaft and the inner race member, which might increase collision load.

One of objects of the invention is to provide a constant velocity joint for a propeller shaft and a propeller shaft, which restrain an increase in collision load at a vehicle collision.

### Solution to Problem

One embodiment of the invention provides a constant velocity joint for a propeller shaft which is provided between a first propeller shaft and a second propeller shaft of a propeller shaft to connect the first propeller shaft and the second propeller shaft, the constant velocity joint comprising an outer race member formed into a cylindrical shape, to which the first propeller shaft of the propeller shaft is connected, the outer race member including an outer race groove portion provided at an inner periphery of the outer race member in a recessed manner so as to be angled to a rotational axis of the constant velocity joint, a first outer race groove end portion situated on the first propeller shaft side of the outer race groove portion, and a second outer race groove end portion situated on the second propeller shaft side of the outer race groove portion; a ball member disposed in the outer race groove portion; and an inner race member provided on the inner peripheral side of the outer race member and connected to the second propeller shaft of the propeller shaft, the inner race member including an inner race groove portion provided at an outer periphery of the inner race member in a recessed manner so as to be angled to the rotational axis of the constant velocity joint and intersect with the outer race groove portion, the inner race groove portion being formed to have a larger outer diameter than the second propeller shaft, a first inner race groove end portion situated on the first propeller shaft side of the inner race groove portion, and a second inner race groove end portion situated on the second propeller shaft side of the inner race groove portion, wherein distance from a position at which the ball member is situated in the outer race groove portion to the first outer race groove end portion of the outer race groove portion is set longer than distance from a position at which the ball member is situated in the inner race groove portion to the second inner race groove end portion of the inner race groove portion.

The constant velocity joint for a propeller shaft and the propeller shaft according to the one embodiment of the invention are thus capable of restraining an increase in collision load at a vehicle collision.

### BRIEF DESCRIPTION OF DRAWINGS

FIG. 1 shows a propeller shaft of Embodiment 1.

FIG. 2 is a cross-sectional view of a constant velocity joint of Embodiment 1.

FIG. 3 is a single item view of an inner race member of the constant velocity joint of Embodiment 1.

FIG. 4 is a cross-sectional view of the constant velocity joint of Embodiment 1 at a collision.

FIG. 5 is a perspective view of a stub shaft before being mounted on the constant velocity joint of Embodiment 1.

FIG. 6 is a cross-sectional view illustrating the mounting of a constant velocity joint of Embodiment 2.

FIG. 7 is a cross-sectional view of a constant velocity joint of Embodiment 3.

### DESCRIPTION OF EMBODIMENTS

### Embodiment 1

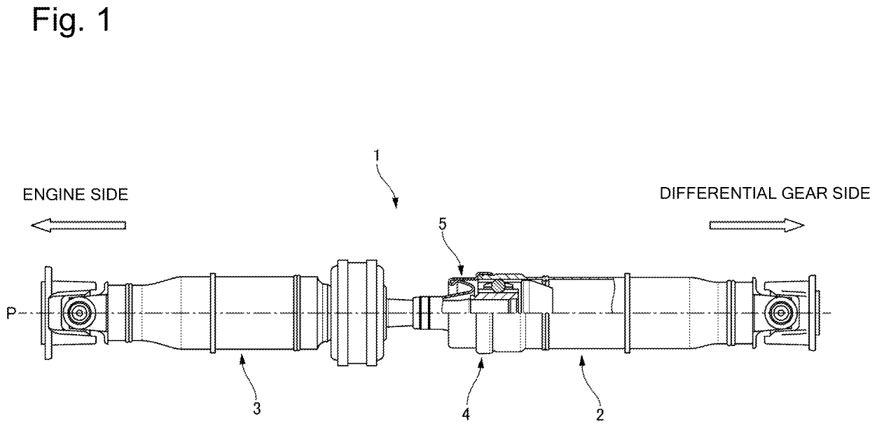

FIG. 1 shows a propeller shaft of Embodiment 1.

### (Configuration of the Propeller Shaft)

A propeller shaft 1 comprises a first propeller shaft 2 that is coupled to a differential gear, not shown, a stub shaft (second propeller shaft) 3 that is connected to an output shaft of a transmission coupled to an engine which is a drive source, not shown, a constant velocity joint 4 connecting the first propeller shaft 2 and the stub shaft 3, and a boot 5 that seals a gap between the stub shaft 3 and the constant velocity joint 4.

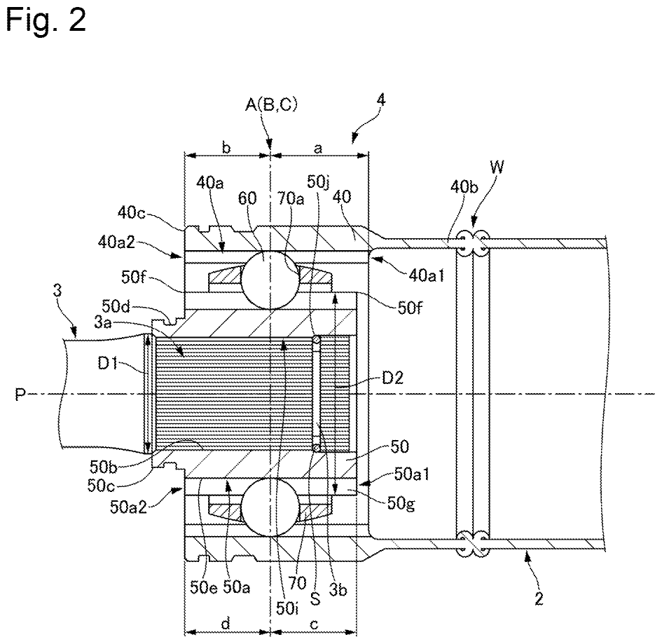

FIG. 2 is a cross-sectional view of the constant velocity joint of Embodiment 1.

### (Configuration of the Constant Velocity Joint)

The constant velocity joint 4 comprises an outer race member 40, an inner race member 50, a cage 70 disposed between the outer race member 40 and the inner race member 50, and a ball 60 that is retained in an open window portion 70a of the cage 70 to couple the outer race member 40 and the inner race member 50.

### (Configuration of the Outer Race)

The outer race member 40 formed into a cylindrical shape includes a first outer race end portion 40b located on the first propeller shaft 2 side and a second outer race end portion 40c located on the second propeller shaft 3 side.

The first outer race end portion 40b is connected via a welded portion W to the first propeller shaft 2 having a tubular shape.

Formed at an inner periphery of the outer race member 40 is an outer race groove portion 40a. The outer race groove portion 40a includes a first outer race groove end portion 40a1 on the first propeller shaft 2 side and a second outer race groove end portion 40a2 on the second propeller shaft 3 side. The outer race groove portion 40a is provided in a recessed manner so as to be angled to a rotational axis P of the constant velocity joint 4. The ball (ball member) 60 is disposed in the outer race groove portion 40a.

The outer race groove portion 40a includes an outer race groove neutral position (position at which the ball member is situated) A between the first outer race groove end portion 40a1 and the second outer race groove end portion 40a2. The outer race groove portion 40a abuts against the ball 60 at the outer race groove neutral position A.

Distance a from the outer race groove neutral position A to the first outer race groove end portion 40a1 is set longer than distance b from the outer race groove neutral position A to the second outer race groove end portion 40a2 (a>b).

### (Configuration of the Cage)

The cage 70 is provided on an inner peripheral side of the outer race member 40 and includes the open window portion 70a that retains the ball 60.

### (Configuration of the Inner Race)

The inner race member 50 is provided on an inner peripheral side of the cage 70 and connected to the stub shaft (second propeller shaft) 3.

Formed at an outer periphery of the inner race member 50 are an inner race groove portion 50a, a small diameter portion 50c, and a jig engagement concave portion 50d. The inner race groove portion 50a includes a first inner race groove end portion 50a1 located on the first propeller shaft 2 side and a second inner race groove end portion 50a2 located on the second propeller shaft 3 side. The inner race groove portion 50a is provided in a recessed manner so as to be angled to the rotational axis P of the constant velocity joint 4 and intersect with the outer race groove portion 40a. The inner race groove portion 50a includes a bottom portion 50e and a wall portion 50g. The ball 60 is disposed in the inner race groove portion 50a. The small diameter portion 50c is formed in a stub shaft 3-side end portion of the inner race member 50 and has a smaller diameter than the bottom portion 50e of the inner race groove portion 50a. The jig engagement concave portion 50d is formed in the small diameter portion 50c and has a smaller diameter than the small diameter portion 50c.

The inner race groove portion 50a includes an inner race groove neutral position (position at which the ball member is situated) B between the first inner race groove end portion 50a1 and the second inner race groove end portion 50a2. The inner race groove portion 50a abuts against the ball 60 at the inner race groove neutral position B.

Distance c from the inner race groove neutral position B to the first inner race groove end portion 50a1 is set equal to distance d from the inner race groove neutral position B to the second inner race groove end portion 50a2 (c=d).

This makes it possible to efficiently secure slide amount.

The distance a from the outer race groove neutral position A to the first outer race groove end portion 40a1 is set longer than the distance c from the inner race groove neutral position B to the first inner race groove end portion 50a1 and the distance d from the inner race groove neutral position B to the second inner race groove end portion 50a2 (a>c=d).

An angulated angular portion 50f is provided at an outer periphery of each of wall portions 50g of the first and second inner race groove end portions 50a1 and 50a2 of the inner race groove portion 50a.

Due to the angular portion 50f, the inner race member 50 can be improved in strength, and thus in durability as well.

A through-hole 50b is formed at the inner periphery of the inner race member 50. An internal spline portion 50i and a snap ring engagement groove portion 50j are formed in an inner peripheral face of the through-hole 50b.

Formed in an outer peripheral face of an end portion of the stub shaft 3 are an external spline portion 3a and a snap ring receiving groove 3b that retains a snap ring S.

The external spline portion 3a of the stub shaft 3 and the snap ring receiving groove 3b retaining the snap ring S are inserted in the through-hole 50b of the inner race member 50. Accordingly, the external spline portion 3a of the stub shaft 3 is meshed with the internal spline portion 50i of the inner race member 50, and an outer periphery of the snap ring S is engaged with the snap ring engagement groove portion 50j of the inner race member 50, to thereby fixedly connect the stub shaft 3 and the inner race member 50.

The wall portion 50g of the inner race groove portion 50a of the inner race member 50 is formed to have outer diameter D2 that is larger than outer diameter D1 of the stub shaft 3.

The outer race groove neutral position A of the outer race groove portion 40a of the outer race member 40 and the inner race groove neutral position B of the inner race groove portion 50a of the inner race member 50, at which the balls 60 are located, are where stress acting on the boot 5 is minimum.

This makes it possible to secure the durability of the boot 5 and enhance the durability of the constant velocity joint 4.

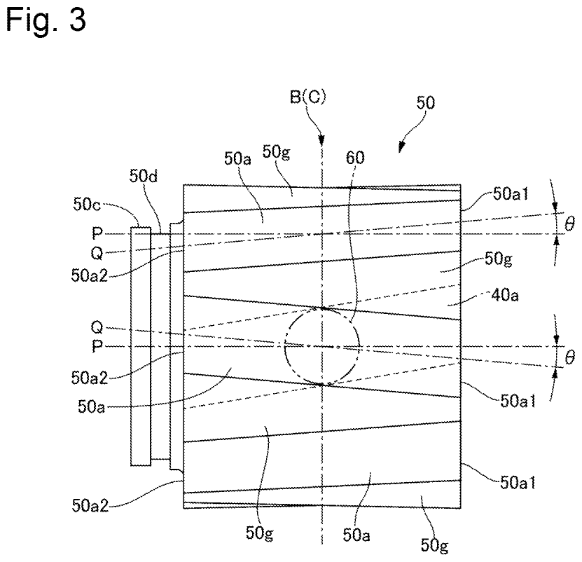

FIG. 3 is a single item view of the inner race member of the constant velocity joint of Embodiment 1.

The inner race groove portion 50a at a center is provided in a recessed manner so that a center line Q is angled clockwise at an angle θ with respect to the rotational axis P of the constant velocity joint 4.

Both inner race groove portions 50a adjacent to the inner race groove portion 50a at the center are formed in a recessed manner so that respective center lines Q are angled anticlockwise at an angle θ with respect to the rotational axis P of the constant velocity joint 4.

In other others, the adjacent inner race groove portions 50a are so provided as to be angled in an opposite direction.

The outer race groove portion 40a shown by broken lines is formed in a recessed manner so as to be angled to and intersect with the rotational axis P of the constant velocity joint 4 and the inner race groove portion 50a at the center.

Like the inner race groove portions 50a, both outer race groove portions 40a adjacent to the outer race groove portion 40a are so provided as to be angled in an opposite direction.

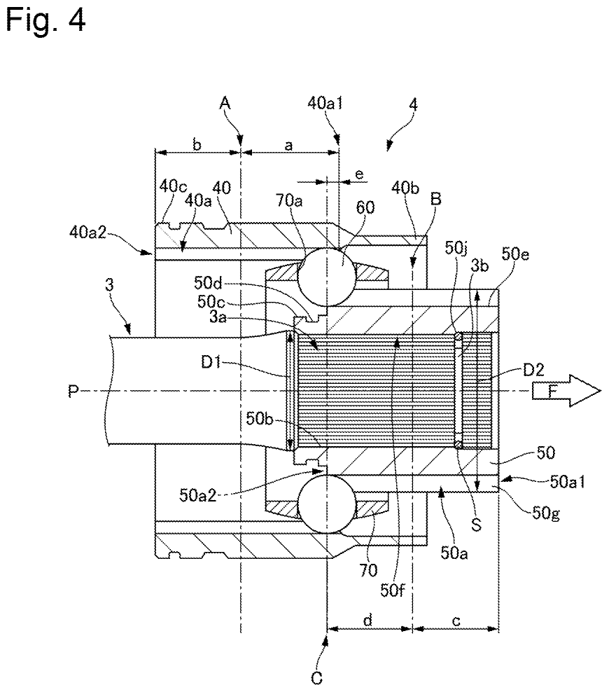

FIG. 4 is a cross-sectional view of the constant velocity joint of Embodiment 1 at a collision.

In other words, the figure illustrates a situation of a vehicle collision where the stub shaft 3 and the inner race member 50 are displaced in an F direction by displacement of an engine, so that a center C of the ball 60 is located in the second inner race groove end portion 50a2 of the inner race groove portion 50a and at the same time, located at distance e on the left side in the figure from the first outer race groove end portion 40a1 of the outer race groove portion 40a.

When the stub shaft 3 and the inner race member 50 are further displaced a shorter distance than the distance e in the F direction, therefore, the ball 60 is detached from the inner race groove portion 50a while being retained in the outer race groove portion 40a.

The ball 60 then escapes into a gap between the outer race 40 and the stub shaft 3.

More specifically, the distance a from the outer race groove neutral position A to the first outer race groove end portion 40a1 is set longer than the distance d from the inner race groove neutral position B to the second inner race groove end portion 50a2 by the distance e (a=d+e). This makes it possible to cause the ball 60 to reliably escape into the gap between the outer race 40 and the stub shaft 3, instead of escaping to the first propeller shaft 2 side.

The ball 60 is thus prevented from getting stuck between the inner race member 50 and the first propeller shaft 2, which restrains an increase in collision load.

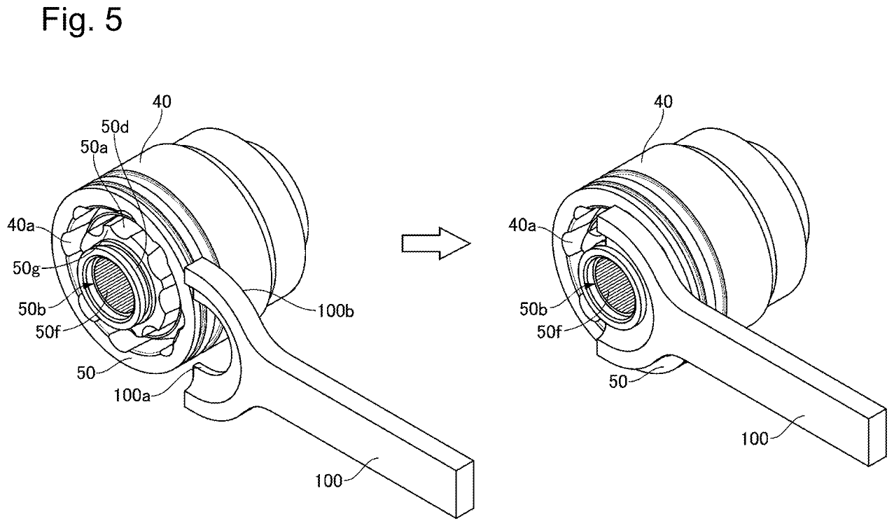

FIG. 5 is a perspective view of the stub shaft before being mounted on the constant velocity joint of Embodiment 1.

Before the subsequent step where the stub shaft 3 is mounted and fastened onto the constant velocity joint 4 on which the outer race member 40, the inner race member 50, and the cage 70 retaining the ball 60 in the window portion 70a are mounted, an engagement portion 100a of a jig 100 is engaged with a jig engagement concave portion 50d of the inner race member 50, and an abutment portion 100b of the jig 100 is brought into abutment against the outer race member 40, to thereby restrain relative displacement between the inner race member 50 and the outer race member 40.

This makes it possible in the subsequent step to insert the stub shaft 3 into the constant velocity joint 4 on which the outer race member 40, the inner race member 50, and the cage 70 retaining the ball 60 in the window portion 70a are mounted, or more specifically, into the through-hole 50b of the inner race member 50. It is therefore possible to enhance assembly workability and also reliability of the propeller shaft 1.

The following discussion explains operation and effects.

The operation and effects of the constant velocity joint for a propeller shaft according to Embodiment 1 are recited below.

(1) Provided are the outer race groove portion 40a formed into a cylindrical shape and provided at the inner periphery of the outer race member 40, to which the first propeller shaft 2 of the propeller shaft 1 is connected, the outer race groove portion 40a being provided in a recessed manner so as to be angled to the rotational axis P of the constant velocity joint 4; the first outer race groove end portion 40a1 situated on the first propeller shaft 2 side of the outer race groove portion 40a; and the second outer race groove end portion 40a2 situated on the second propeller shaft 3 side of the outer race groove portion 40a. The outer race groove neutral position A is set between the first outer race groove end portion 40a1 and the second outer race groove end portion 40a2. Further provided are the ball 60 disposed at the outer race groove neutral position A; the inner race groove portion 50a formed at the outer periphery of the inner race member 50 that is provided on the inner peripheral side of the outer race member 40 and connected to the second propeller shaft 3 of the propeller shaft 1, the inner race groove portion 50a being formed in a recessed manner so as to be angled to the rotational axis P of the constant velocity joint 4 and intersect with the outer race groove portion 40a, the inner race groove portion 50a being formed have the outer diameter D2 that is larger than the outer diameter D1 of the second propeller shaft 3; the first inner race groove end portion 50a1 situated on the first propeller shaft 2 side of the inner race groove portion 50a; and the second inner race groove end portion 50a2 situated on the second propeller shaft 3 side of the inner race groove portion 50a. The inner race groove neutral position B at which the ball 60 is disposed is set between the first inner race groove end portion 50a1 and the second inner race groove end portion 50a2. The distance a from the outer race groove neutral position A to the first outer race groove end portion 40a1 is set longer than the distance d from the inner race groove neutral position B to the second inner race groove end portion 50a2 by the distance e (a=d+e).

At a vehicle collision, therefore, the ball 60 surely can escape into the gap between the outer race 40 and the stub shaft 3, instead of escaping to the first propeller shaft 2 side.

This makes it possible to prevent the ball 60 from getting stuck between the inner race member 50 and the first propeller shaft 2 and restrain an increase in collision load.

(2) The distance c from the inner race groove neutral position B to the first inner race groove end portion 50a1 is set equal to the distance d from the inner race groove neutral position B to the second inner race groove end portion 50a2 (c=d).

This makes it possible to efficiently secure slide amount.

(3) The outer race groove neutral position A of the outer race groove portion 40a of the outer race member 40 and the inner race groove neutral position B of the inner race groove portion 50a of the inner race member 50, at which the balls 60 are located, are where the stress acting on the boot 5 is minimum.

This makes it possible to secure the durability of the boot 5 and also enhance the durability of the constant velocity joint 4.

(4) Before the subsequent step where the stub shaft 3 is mounted and fastened onto the constant velocity joint 4 on which the outer race member 40, the inner race member 50, and the cage 70 retaining the ball 60 in the window portion 70a are mounted, the engagement portion 100a of the jig 100 is engaged with the jig engagement concave portion 50d of the inner race member 50, and the abutment portion 100b of the jig 100 is brought into abutment against the outer race member 40, to thereby restrain the relative displacement between the inner race member 50 and the outer race member 40.

This makes it possible in the subsequent step to insert the stub shaft 3 into the constant velocity joint 4 on which the outer race member 40, the inner race member 50, and the cage 70 retaining the ball 60 in the window portion 70a are mounted, or more specifically, into the through-hole 50b of the inner race member 50. It is therefore possible to enhance assembly workability and also reliability of the propeller shaft 1.

(5) The angulated angular portion 50f is provided at an outer periphery of each of the wall portions 50g of the first and second inner race groove end portions 50a1 and 50a2 of the inner race groove portion 50a.

Due to the angular portion 50f, the inner race member 50 can be improved in strength, and thus in durability as well.

### Embodiment 2

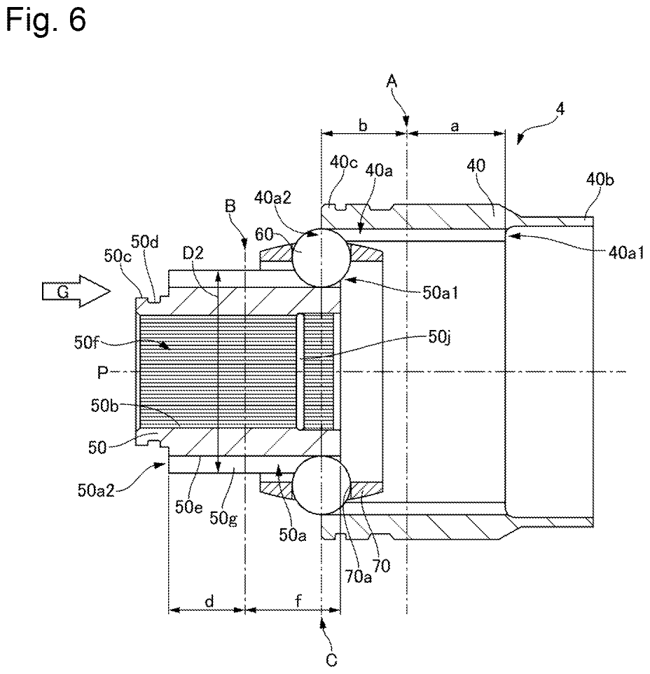

FIG. 6 is a cross-sectional view illustrating the mounting of a constant velocity joint of Embodiment 2.

In Embodiment 1, the distance c from the inner race groove neutral position B to the first inner race groove end portion 50a1 is set equal to the distance d from the inner race groove neutral position B to the second inner race groove end portion 50a2 (c=d). In Embodiment 2, however, distance f from the inner race groove neutral position B to the first inner race groove end portion 50a1 is set longer than the distance d from the inner race groove neutral position B to the second inner race groove end portion 50a2 (f>d).

As other configurations are similar to Embodiment 1, the similar configurations are provided with the same reference signs, and explanations thereof are omitted.

Embodiment 2 accordingly provides the operation and effects of Embodiment 1 and further provides operation and effects that, when the cage 70 retaining the ball 60 in the window portion 70a and the inner race member 50 are mounted on the outer race member 40, it is possible to use the first inner race groove end portion 50a1 as a receiving guide for the ball 60, to thereby enhance mounting performance.

### Embodiment 3

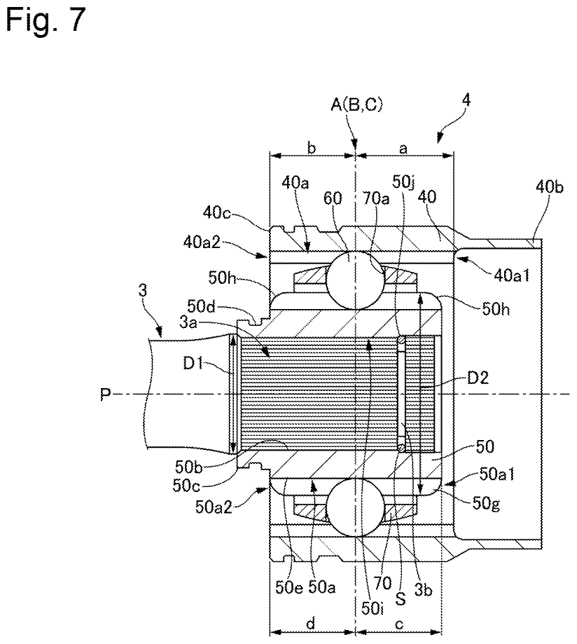

FIG. 7 is a cross-sectional view of a constant velocity joint of Embodiment 3.

In Embodiment 1, the angulated angular portion 50f is provided at the outer periphery of each of the wall portions 50g of the first and second inner race groove end portions 50a1 and 50a2 of the inner race groove portion 50a. In Embodiment 3, however, a chamfered portion 50h is provided at the outer periphery of each of the wall portions 50g of the first and second inner race groove end portions 50a1 and 50a2 of the inner race groove portion 50a.

As other configurations are similar to Embodiment 1, the similar configurations are provided with the same reference signs, and explanations thereof are omitted.

Embodiment 3 therefore can provide the operation and effects of Embodiment 1, except for (5). Embodiment 3 further can provide operation and effects of preventing the chipping of the wall portions 50g of the first and second inner race groove end portions 50a1 and 50a2 of the inner race groove portion 50a and enabling a reduction in a wright thereof.

### Other Embodiments

The embodiments for carrying out the invention have been explained above.

Specific configurations of the invention, however, are not limited to the configurations of the embodiments. The invention includes modifications in design or the like without deviating from the gist of the invention.

For example, according to the embodiments, the angulated angular portions or the chamfered portions are provided at the outer peripheries of both the wall portions 50g of the first or second inner race groove end portions 50a1 and 50a2 of the inner race groove portion 50a. However, it is also possible to provide the angulated angular portion or the chamfered portion only at either one of the outer peripheries of the wall portions 50g of the first or second inner race groove end portions 50a1 and 50a2 of the inner race groove portion 50a.

The invention is not limited to the foregoing embodiments but may include various modifications. For example, the foregoing embodiments are explained in details for comprehensible explanation of the invention and do not necessarily have to include all the configurations explained above. The configurations of the embodiments may be partially replaced with one another, and the configuration of any one of the embodiments may be incorporated into another one of the embodiments. Any one of the configurations of the embodiments may be partially incorporated into or replaced with the configuration of another one of the embodiments or partially deleted.

The present patent application claims priority under Japanese Patent Application No. 2021-147399 filed on Sep. 10, 2021. The entire disclosure of Japanese Patent Application No. 2021-147399 filed on Sep. 10, 2021 including description, claims, drawings and abstract is incorporated herein by reference in its entity.

### REFERENCE SIGNS LIST

1 Propeller shaft; 2 First propeller shaft; 3 Stub shaft (second propeller shaft); 4 Constant velocity joint; 5 Boot; 40 Outer race member; 40a Outer race groove portion; 40a1 First outer race groove end portion; 40a2 Second outer race groove end portion; 50 Inner race member; 50a Inner race groove portion; 50a1 First inner race groove end portion; 50a2 Second inner race groove end portion; 50b Through-hole; 50c Small-diameter portion; 50d Jig engagement concave portion; 50e Bottom portion; 50f Angular portion; 50g Wall portion; 50h Chamfered portion; 50i Internal spline portion; 60 Ball (ball member); a Distance from the outer race groove neutral position to the first outer race groove end portion; b Distance from the outer race groove neutral position to the second outer race groove end portion; c Distance from the inner race groove neutral position to the first inner race groove end portion; d Distance from the inner race groove neutral position to the second inner race groove end portion; f Distance from the inner race groove neutral position to the first inner race groove end portion; A Outer race groove neutral position (position at which the ball member is situated); B Inner race groove neutral position (position at which the ball member is situated); P Rotational axis of the propeller shaft and the constant velocity joint

1.-11. (canceled)

12. A constant velocity joint for a propeller shaft which is provided between a first propeller shaft and a second propeller shaft of a propeller shaft to connect the first propeller shaft and the second propeller shaft,
the constant velocity joint comprising an outer race member formed into a cylindrical shape, to which the first propeller shaft of the propeller shaft is connected,
the outer race member including:
an outer race groove portion provided at an inner periphery of the outer race member in a recessed manner so as to be angled to a rotational axis of the constant velocity joint;
a first outer race groove end portion situated on the first propeller shaft side of the outer race groove portion; and a second outer race groove end portion situated on the second propeller shaft side of the outer race groove portion,
the constant velocity joint further comprising:
a ball member disposed in the outer race groove portion, and
an inner race member provided on the inner peripheral side of the outer race member and connected to the second propeller shaft of the propeller shaft,
the inner race member including:
an inner race groove portion provided at an outer periphery of the inner race member in a recessed manner so as to be angled to the rotational axis of the constant velocity joint and intersect with the outer race groove portion, the inner race groove portion being formed to have a larger outer diameter than the second propeller shaft;
a first inner race groove end portion situated on the first propeller shaft side of the inner race groove portion; and a second inner race groove end portion situated on the second propeller shaft side of the inner race groove portion,
wherein distance from a position at which the ball member is situated in the outer race groove portion to the first outer race groove end portion of the outer race groove portion is set longer than distance from a position at which the ball member is situated in the inner race groove portion to the second inner race groove end portion of the inner race groove portion,
wherein the outer race groove portion includes an outer race groove neutral position that is provided between the first outer race groove end portion and the second outer race groove end portion, the outer race groove neutral position being where the outer race groove portion abuts against the ball member, and
wherein the inner race groove portion includes an inner race groove neutral position that is provided between the first inner race groove end portion and the second inner race groove end portion, the inner race groove neutral position being where the inner race groove portion abuts against the ball member,
wherein distance from the inner race groove neutral position to the first inner race groove end portion is set longer than distance from the inner race groove neutral position to the second inner race groove end portion, and distance from the outer race groove neutral position to the first outer race groove end portion is set longer than the distance from the inner race groove neutral position to the second inner race groove end portion.

13. The constant velocity joint for a propeller shaft according to claim 12,
wherein distance from the outer race groove neutral position to the first outer race groove end portion is set longer than distance from the inner race groove neutral position to the second inner race groove end portion.

14. The constant velocity joint for a propeller shaft according to claim 12,
wherein distance from the inner race groove neutral position to the first inner race groove end portion is set substantially equal to distance from the inner race groove neutral position to the second inner race groove end portion.

15. The constant velocity joint for a propeller shaft according to claim 12, further comprising a boot that covers a gap between the outer race member and the second propeller shaft, wherein the outer race groove neutral position or the inner race groove neutral position is located where stress acting on the boot is minimum, and the position is where the ball member is situated.

16. A constant velocity joint for a propeller shaft which is provided between a first propeller shaft and a second propeller shaft of a propeller shaft to connect the first propeller shaft and the second propeller shaft,
the constant velocity joint comprising an outer race member formed into a cylindrical shape, to which the first propeller shaft of the propeller shaft is connected,
the outer race member including:
an outer race groove portion provided at an inner periphery of the outer race member in a recessed manner so as to be angled to a rotational axis of the constant velocity joint;
a first outer race groove end portion situated on the first propeller shaft side of the outer race groove portion; and a second outer race groove end portion situated on the second propeller shaft side of the outer race groove portion,
the constant velocity joint further comprising:
a ball member disposed in the outer race groove portion, and
an inner race member provided on the inner peripheral side of the outer race member and connected to the second propeller shaft of the propeller shaft,
the inner race member including:
an inner race groove portion provided at an outer periphery of the inner race member in a recessed manner so as to be angled to the rotational axis of the constant velocity joint and intersect with the outer race groove portion, the inner race groove portion being formed to have a larger outer diameter than the second propeller shaft;
a first inner race groove end portion situated on the first propeller shaft side of the inner race groove portion; and a second inner race groove end portion situated on the second propeller shaft side of the inner race groove portion,
wherein distance from a position at which the ball member is situated in the outer race groove portion to the first outer race groove end portion of the outer race groove portion is set longer than distance from a position at which the ball member is situated in the inner race groove portion to the second inner race groove end portion of the inner race groove portion,
wherein the second propeller shaft is a stub shaft, and
wherein the inner race member comprises a through-hole provided on a further inner peripheral side than the inner race groove portion, the through-hole in which the stub shaft is inserted; a small-diameter portion formed on the second inner race groove end portion side to have a smaller diameter than the inner race groove portion; and a jig engagement concave portion formed to have a smaller diameter than the small-diameter portion.

17. The constant velocity joint for a propeller shaft according to claim 16,
wherein an angulated angular portion is provided at an outer periphery of at least one of circumferential wall portions of the first or second inner race groove end portions of the inner race groove portion.

18. The constant velocity joint for a propeller shaft according to claim 16,
wherein a chamfered portion is provided at an outer periphery of at least one of wall portions in the peripheral direction of the first or second inner race groove end portions.

19. A propeller shaft, the propeller shaft comprising:
a first propeller shaft of the propeller shaft;
a second propeller shaft provided at an opposite position to the first propeller shaft of the propeller shaft; and
a constant velocity joint disposed between the first propeller shaft and the second propeller shaft to connect the first propeller shaft and the second propeller shaft,
the constant velocity joint including an outer race member connected to the first propeller shaft, an inner race member disposed on an inner side of the outer race member and connected to the second propeller shaft, and a ball member provided between the outer race member and the inner race member,
the outer race member being formed into a cylindrical shape and including a first outer race end portion situated on the first propeller shaft side and a second outer race end portion situated on the second propeller shaft side,
the first propeller shaft, to which the first outer race end portion is connected,
the outer race member including:
an outer race groove portion provided at an inner periphery of the outer race member between the first outer race end portion and the second outer race end portion to be angled to a rotational axis of the constant velocity joint;
a first outer race groove end portion situated on the first propeller shaft side of the outer race groove portion; a second outer race groove end portion situated on the second propeller shaft side of the outer race groove portion; and an outer race groove neutral position that is set between the first outer race groove end portion and the second outer race groove end portion,
the ball member being disposed at the outer race groove neutral position,
the inner race member including:
an inner race groove portion provided at an outer periphery of the inner race member to be angled to the rotational axis of the constant velocity joint and intersect with the outer race groove portion, the inner race groove portion being formed to have a larger outer diameter than the second propeller shaft;
a first inner race groove end portion situated on the first propeller shaft side of the inner race groove portion; a second inner race groove end portion on the second propeller shaft side of the inner race groove portion; and an inner race groove neutral position that is set between the first inner race groove end portion and the second inner race groove end portion, the inner race groove neutral position being where the ball member is disposed,
wherein distance from the outer race groove neutral position to the first outer race end portion is set longer than distance from the inner race groove neutral position to the second inner race end portion,
wherein the second propeller shaft is a stub shaft, and
wherein the inner race member comprises a through-hole provided on a further inner peripheral side than the inner race groove portion, the through-hole in which the stub shaft is inserted; a small-diameter portion formed on the second inner race groove end portion side to have a smaller diameter than the inner race groove portion; and a jig engagement concave portion formed to have a smaller diameter than the small-diameter portion.
